(19) United States
(12) Patent Application Publication
(10) Pub. No.: US 2026/0219086 A1
(43) Pub. Date: Jul. 30, 2026

(54) PROPORTIONAL VOLUMETRIC DOSING DEVICE

(71) Applicant: MIXTRON S.R.L., REGGIO EMILIA (IT)

(72) Inventors: Renato BREVINI, REGGIO EMILIA (IT); Stefano BREVINI, REGGIO EMILIA (IT)

(21) Appl. No.: 19/148,515

(22) PCT Filed: Dec. 20, 2023
(86) PCT No.: PCT/IB2023/063026

§ 371 Date: Jul. 16, 2025

(30) Foreign Application Priority Data
Jan. 24, 2023 (IT) 102023000000987

(51) Int. Cl. G01F 11/02

(52) U.S. Cl. CPC G01F 11/029

(57) ABSTRACT

A proportional volumetric dosing device (1, 1′) is described, comprising a motor (20) provided with an inlet port (11) of a first liquid and an output shaft (31) movable along a respective sliding axis (X) between a top dead centre position and a bottom dead centre position. The dosing device also comprises a pump (25, 25′) fixed to the motor and adapted to be driven by said output shaft. Said pump comprises a tubular body (300) coaxial to the output shaft and provided with an inner tubular surface (305) defining an inner volume (310) of the pump in which the output shaft (31) is partially inserted in its movement between the bottom dead centre and the top dead centre, said tubular body comprising a first longitudinal end, distal from the motor, near or at which the inner tubular surface makes available an inlet port (315) of a second liquid to be pumped, and an opposite second longitudinal end, proximal to the motor, and near or at which the inner tubular surface makes available an outlet port (320) of the second liquid. The pump also comprises a sleeve (330) which connects the tubular body (300) to the motor and is provided with an inner volume (335) in fluid communication with the outlet port (320) of the second liquid, an annular sealing gasket (350, 350′), which gasket is provided with: an inner annular surface (355) in which a section of the output shaft (31) sealingly slides at least when the output shaft is at the bottom dead centre, an outer annular surface (360) opposite the inner annular surface, a first face (365) connecting the inner annular surface to the outer annular surface and a second face (370) opposite to the first face, and a pushing device (405) which generates a thrust on the annular scaling gasket in a direction for holding the annular scaling gasket in contact with the housing seat, thereby creating a hermetic sealing therewith.

### TECHNICAL FIELD OF THE INVENTION

The object of the invention is a proportional volumetric dosing device, in particular of the type driven only by the energy provided by the flow of a first liquid, wherein the dosing device must mix a predetermined amount of a second liquid.

### PRIOR ART

As known, a proportional volumetric dosing unit is a device that allows a first liquid to be mixed with a second liquid, for example containing an additive or an active ingredient, for a variety of applications in all those sectors where it is necessary to mix, in precise proportions, a first liquid with a second liquid or an additive. The first liquid may typically be water and the second liquid may be, according to the applications, oils, fertilizers, detergents, chemical products or products intended for the pharmaceutical industry, in a solution or the like, according to the application sector of the dosing device.

Said dosing devices operate without having to be connected to electric power sources, but only by the effect of the pressure and flow rate of the first liquid.

Such dosing devices have a hydraulic motor provided with a body within which a piston, slidably inserted into a cylinder of said body along a sliding axis, is made to translate, and which drives a pump of the dosing device itself, which has the function of supplying into the motor body, or into a by-pass duct connected to a motor outlet duct, the second liquid that mixes with the first liquid.

The pump comprises a tubular sleeve coaxial to the piston sliding axis and a hole, formed in the body of the pump, for inletting the second liquid in the motor. The tubular sleeve is holed in the middle and has, at a connection end with the body of the motor, a seat housing a one-way diaphragm valve which is placed at the inlet duct of the second liquid and allows the passage of the second liquid from the pump to the body of the motor.

A cylinder that has an outer threaded portion is received inside the tubular sleeve. The cylinder has, near an upper end, a seat housing said annular sealing gasket configured to prevent the passage of fluid between the tubular sleeve and the cylinder.

At the distal end from the motor body, the cylinder has a seat housing a one-way valve, usually of the ball type, which allows the secondary fluid to enter the cylinder, but prevents it from leaving.

Inside the cylinder a small piston of the pump, which is mechanically and rigidly connected to the piston of the motor, i.e. to an output shaft of the motor integral with the piston, (rigidly connected in such a way that the stroke of the small piston is the same as the piston), slides.

The inner volume of the cylinder, together with the small piston and the one-way valve, define a pumping chamber of the second liquid.

On the threaded portion of the cylinder, an outer ring nut is screwed, which has an enlarged end that is housed in a conjugated annular lowering obtained in an enlarged end portion of the tubular sleeve.

A closing cover configured to keep the enlarged end of the ring nut in the annular lowering obtained in an enlarged end portion of the tubular sleeve is associated with the lower end of the tubular sleeve.

The ring nut rotation results in the axial translation of the cylinder, thereby varying the volume of the pumping chamber and hence the amount of second liquid it can contain. In fact, since the stroke of the small dosing piston is constant, the adjustment of the amount of the second liquid that is first drawn in and then fed into the motor body is carried out by adjusting the volume of the pumping chamber.

The small piston comprises a plurality of openings, radially arranged relative to the sliding axis of the small piston itself and coaxial to said axis, for the outflow of the secondary liquid contained within the dosing chamber towards the motor body. Said openings are associated to a valve that allows the secondary liquid to flow through them and comprises an annular friction gasket, generally with a circular cross-section, which is housed in an annular groove in the small piston formed in a side surface of the small piston and which intersects the openings formed in the small piston itself. Such gasket slides in contact with the cylinder and during the downward movement of the small dosing piston, rubbing along the inner surface of the cylinder, it reaches, thanks to the friction, a position wherein it allows the outflow of the second liquid, previously drawn in, through the openings of the piston, while during the upward movement of the small dosing piston, rubbing along the inner surface of the cylinder 85, the gasket reaches a position at which it prevents the second liquid from flowing through said openings, instantly producing a depression in the chamber which allows the second liquid to be drawn into the pumping chamber.

A dosing device provided with such a pump is for instance described in U.S. patent Ser. No. 11/499,858B2 to the same Applicant.

As it may be inferred from the above-provided description, in order to vary the amount of second liquid drawn in at each pump cycle, it is possible to act on the sleeve to vary the length of the pumping chamber. However, when the second liquid has to be particularly diluted relative to the first liquid, i.e. the amount of the second liquid has to be particularly low, it is difficult to produce an efficient pump.

In particular, in order to reduce the amount of second liquid drawn in, it is possible to act on the volume of the pumping chamber, in particular on the diameter of the cylinder. However, such a solution is not optimal, in that when reaching particularly small piston diameters, e.g. lower than 5 mm, the sliding gasket becomes too small, to create a housing seat on the piston, and thin, and the friction it can exert is too low to effectively close the piston holes at the usual pressures of these dosing devices, i.e. 2 bars-6 bars. Moreover, when the diameter is particularly small, the gasket is complex and expensive to manufacture.

An object of the present invention is to overcome the aforementioned constraints of the prior art by means of the features of the independent claim, which outlines a cost-effective, strong and efficient solution. The dependent claims outline preferred and/or particularly advantageous aspects of the invention.

### DISCLOSURE OF THE INVENTION

In particular, the invention makes available a proportional volumetric dosing device comprising a motor provided with an inlet port of a first liquid and an output shaft movable along a respective sliding axis between a top dead centre position and a bottom dead centre position. The volumetric dosing device also comprises a pump fixed to the motor and adapted to be driven by said output shaft. Such pump comprises:
a tubular body coaxial to the output shaft and provided with an inner tubular surface defining an inner volume of the pump in which the output shaft is partially inserted in its movement between the bottom dead centre and top dead centre, said tubular body comprising a first longitudinal end, distal from the motor, near or at which the inner tubular surface makes available an inlet port of a second liquid to be pumped and an opposite second longitudinal end, proximal to the motor, and near or at which the inner tubular surface makes available an outlet port of the second liquid,
a sleeve that connects the tubular body to the motor and is provided with an inner volume in fluid communication with the outlet port of the second liquid,
an annular sealing gasket, which gasket is provided with: an inner annular surface into which a section of the output shaft sealingly slides at least when the output shaft is at the bottom dead centre, an outer annular surface opposite the inner annular surface, a first face connecting the inner annular surface to the outer annular surface, and a second face opposite the first face, and
a pushing device which generates a thrust on the annular sealing gasket in a direction that keeps the annular sealing gasket in contact with the housing seat creating a hermetic sealing with it.

A pump for a volumetric dosing device is thereby made available which is capable of achieving extremely low dosing percentages, e.g. between 0.005%-0.025% (to be understood as the percentage of the second liquid in the first liquid), or between 50 ppm and 250 ppm (parts per million of the second liquid), as it is possible to create inner tubular surfaces of the tubular body with extremely small diameters, e.g. lower than 5 mm, without the gaskets being a problem, as the sealing gasket, thanks to the proposed solution, does not need to have a maximum diameter smaller than the cylinder diameter, on the contrary, the minimum diameter of the sealing gasket is slightly smaller than the diameter of the cylinder.

The sealing gasket, in such configuration, is movable between a closed position, wherein it creates a hermetic sealing with the housing seat and the inner volume of the tubular body is isolated from the volume of the sleeve (the grooves or holes are isolated from the inner volume or the other volume), and an open position, wherein it is at least partially spaced apart from the housing seat and the inner volume of the tubular body is in communication with the volume of the sleeve.

Such an annular sealing gasket is movable between the closed position and the open position according to a balance, i.e. a difference, of forces acting on the annular sealing gasket, where these forces comprise a pressure in the inner volume, the thrust exerted by the pushing device, a frictional force between the output shaft and the inner annular surface, and possibly a pressure in the inner volume of the sleeve that would push on the second face of the annular sealing gasket.

In particular, when the output shaft moves into the inner volume, thus moving towards the bottom dead centre, the pressure in the inner volume increases and when this pressure exceeds that of the pushing device (and possibly the friction on the output shaft) it brings the annular sealing gasket into the open position. When, on the other hand, the output shaft moves out of the inner volume, i.e. towards the top dead centre, the pressure in the inner volume drops, i.e. it becomes a depression, and the pushing device returns the annular sealing gasket to the closed position.

In addition to or as an alternative to said gap, (at least) one of the housing seat and the annular sealing gasket (in the embodiments shown only one of the housing seat and the annular sealing gasket, but it is not excluded that they both may) comprises a groove or hole which, when the annular sealing gasket is sealingly housed in the housing seat (is in the closed position), i.e. the sealing portions are in contact, is isolated from the inner volume of the sleeve and/or from the inner volume of the tubular body, i.e. from the pumping chamber, and when the annular sealing gasket, by contrast, is not sealingly housed in the housing seat (i.e. is in the open position), i.e. such portions do not create a sealing, such grooves or through holes put the inner volume of the sleeve in fluid communication with the inner volume of the tubular body.

Thanks to such solution, a strong, efficient system that keeps the annular sealing gasket stable in its movement, without any clearance, is made available. As a result, said gasket is less likely to rotate relative to the direction of movement and thus get stuck.

In further detail, the housing seat of the annular sealing gasket comprises an abutment surface, which originates from the inner tubular surface of the tubular body in a direction moving away from the sliding axis and transverse to it, and a side surface, which is coaxial to the sliding axis and extends from the abutment surface transversally to the abutment surface (moving closer to the motor, in other words the housing seat thus creates an enlarged portion of the tubular surface)
wherein at least either an annular portion of the first face and an annular portion of the abutment surface, or a portion of the outer annular surface and a portion of the side surface of the housing seat, create a hermetic sealing under the thrust exerted on the annular sealing gasket by the pushing device when the annular sealing gasket is in the closed position
and wherein at least one of the annular gasket and the housing seat comprises a groove or a hole which fluidically connects the inner volume of the tubular body (i.e. the housing seat and the outlet port) with the inner volume of the sleeve when the annular sealing gasket is in the open position and said annular portions which create the hermetic sealing under the force of the pushing device are spaced apart from each other.

The annular sealing gasket may thereby occupy most of the housing seat, without any clearance, so that it is less likely that said gasket can rotate relative to the direction of movement and thus get stuck.

In an embodiment, the outer annular surface of the annular sealing gasket is substantially cylindrical and continuous without interruptions, and the side wall of the housing seat comprises grooves that fluidically connect the inner volume of the tubular body (i.e. the housing seat and the outlet port) with the inner volume of the sleeve when the annular sealing gasket is not sealingly housed in the housing seat.

In another embodiment, the side surface of the housing seat does not comprise grooves or holes, and the annular sealing gasket comprises protuberances that extend from the outer annular surface and whose free ends slide in contact with the side surface. Such protuberances are equivalent to the creation, in the annular sealing gasket, of holes between the first face and the second face or grooves in the outer annular surface extending from the first face to the second face, in fact the space between two protuberances adjacent to each other may be defined as a groove.

According to an aspect of the invention, alternative or additional to the grooves or holes in the housing seat or in the annular sealing gasket, the annular sealing gasket is housed in the housing seat with a (small) clearance relative to the side surface of the housing seat. In particular, there may preferably be an annular gap between the side surface of the housing seat and the outer annular surface of the housing gasket. For example, such annular gap encloses at least partially, preferably all, of the outer annular surface of the gasket.

Even if the grooves on the annular sealing gasket are made available by protrusions extending from the outer tubular surface of the annular sealing gasket, such annular gap has an extension in the direction radial to the sliding axis such that even the protrusions do not touch the side surface of the housing seat. The use of grooves (in the gasket and/or housing seat) and/or passage holes, in addition to the annular gap, makes it possible to keep a passage section sufficient for the second liquid and at the same time makes it possible to reduce the size of the gap, thus reducing the clearance relative to the housing seat, so as to avoid gasket entrapment and jamming.

The following aspects, which the dosing device may have, are independent of the design of the annular sealing gasket.

According to one aspect of the invention, the pump may comprise an anti-stagnation duct, defining a narrow portion of the housing seat opposite the abutment surface, which extends in the direction moving closer to the motor and which is crossed by the motor output shaft.

It is thereby possible to inject the second liquid closer to the motor, thus reducing the likelihood of stagnation of the second liquid once pumped.

According to another aspect of the invention, the pump may comprise a pushing device holding body, which holding body is crossed by the output shaft, is removably (non-permanently) fixed to the tubular body, and holds the pushing device in place.

It is thereby possible to have access to the pushing device and the gasket to change them without having to change the entire pump, thus reducing maintenance costs. In an alternative embodiment, whose object is to simplify the replacement of the gasket and the pushing device, the holding body is crossed by the output shaft and is permanently (nonremovably) fixed to the tubular body, and wherein the tubular body is removably connected to the sleeve. The tubular body, the pushing device, the gasket and the holding body thereby substantially form an indivisible cartridge which may be replaced as a single body in case of maintenance, making maintenance more expensive than the other embodiment, but easier for people who are not skilled in it, e.g. adapted for home maintenance.

In this case, in which the pump substantially comprises a replaceable cartridge which comprises the pushing device and the annular sealing gasket, the pump may also comprise:
a one-way valve housed in a respective housing seat made at the first end of the tubular body and acting on the inlet port of the second liquid
an additional tubular body, into which the tubular body is (entirely) inserted, provided with a first longitudinal end that is proximal to the motor and an opposite second longitudinal end, where said first longitudinal end has a bottom wall transverse to the sliding axis, which is crossed by the output shaft and on which the second longitudinal end of the tubular body or the holding body abuts,
wherein the second longitudinal end is partially closed by a plug (removably) associated with the additional tubular body, and the one-way valve is clamped between its housing seat and the plug (said plug having a through-hole communicating with said valve and wherein the plug has connecting means for connecting a pipe adapted to be flown through by the second liquid).

In this way, the cartridge, whose casing is substantially the additional tubular body into which the tubular body is inserted, also comprises the one-way valve through which the second liquid enters the pump, making it possible to change all of the aforementioned components by extracting a single body from the pump.

In the present invention, the pushing device may preferably comprise or consist of a spring, e.g. a compression coil spring, which may in particular be interposed pre-compressed between the annular sealing gasket and the holding body. It is not excluded that in alternative embodiments, the pushing device could comprise elastic links, or it could be electromechanical (e.g. actuated by a solenoid) or it could be hydraulic.

According to another aspect of the invention, the compression coil spring may comprise a first end in contact with the annular sealing gasket and an opposite second end in contact with the holding body, and wherein the holding body comprises a groove in which a turn of the second end is retained.

This makes it quick and easy to properly position the spring during the assembly step and remove it during the disassembly step (e.g. for maintenance purposes).

According to a further aspect of the invention, the inner volume of the sleeve is in (direct) fluid communication with the inner volume of the motor in (direct) fluid communication with the inlet port of the first liquid or with a by-pass duct of the dosing device.

In the present invention, the dosing device is preferably of the variable dosing type, and the configuration described in claim 1 is particularly important when the dosing device is of the variable dosing type, since with conventional pumps, it is required that a rotation of the ring nut by a minimum angle, that may be imparted by the user, causes the cylinder to shift by a few tenths of a millimetre, making it difficult to produce the adjustment mechanism.

As mentioned above, the dosing device is preferably of the variable dosing type and therefore the tubular body of the pump may be movably associated with the motor, i.e. the sleeve, in a sliding manner along the sliding axis, and the pump comprises a mechanism for varying the position of the tubular body, configured to allow the sliding of the tubular body along the sliding axis with respect to the sleeve and the (stable) positioning of the tubular body 300 in a plurality of positions along the sliding axis.

In the embodiment shown, the mechanism for varying the position of the tubular body comprises a ring nut mechanism where a rotation of said ring nut around the sliding axis corresponds to a translation of the tubular body along the sliding axis.

### BRIEF DESCRIPTION OF THE DRAWINGS

Further features and advantages of the invention will be more apparent after reading the following description provided by way of non-limiting example, with the aid of the accompanying drawings.

FIG. 1 is a section view of a proportional volumetric dosing device according to the invention represented in an operating configuration, wherein an output shaft of a motor of the piston is in a bottom dead centre position.

FIG. 2 is the same section view of the dosing device of FIG. 1, in which the dosing device is shown in another operating configuration, wherein the output shaft is in a top dead centre position.

FIG. 3 is an enlargement of FIG. 1, wherein only one pump of the dosing device, which is connected to the motor of the dosing device, is shown. Such a pump is shown in a minimum dosing condition of a second liquid.

FIG. 4 is an enlargement of FIG. 2, wherein only the pump of the dosing device is shown.

FIG. 5 is an enlargement of the detail V of FIG. 3.

FIG. 6 is an enlargement of FIG. 5 shown in an operating condition wherein the second liquid is being pumped to the motor.

FIG. 7 is the pump of FIG. 3, wherein the output shaft is at the bottom dead centre, however shown in a maximum dosing condition of the second liquid.

FIG. 8 is a section view of another embodiment of a proportional volumetric dosing device according to the invention, depicted in an operating configuration, wherein an output shaft of a motor of the piston is in a bottom dead centre position.

FIG. 9 is the enlargement of the detail XIX of FIG. 8.

FIG. 10 is an orthogonal view of an annular sealing gasket of the volumetric dosing devices of the previous figures.

FIG. 11 is a section view according to the section plane XXI-XXI of the annular sealing gasket of FIG. 10.

FIG. 12 is an enlarged view of a detail of the pump modified to operate with an embodiment of the annular sealing gasket different from that shown in FIGS. 10 and 11.

FIG. 13 is an enlargement of the detail XIII of FIG. 2.

### BEST MODE OF THE INVENTION

Referring in particular to such figures, a (piston) proportional volumetric dosing device, which is adapted to mix a first liquid (main liquid) entering from an inlet port 11 of an inlet duct 10 with a second liquid (auxiliary liquid) so as to output, in an outlet port 16 of an outlet duct 15, a mixed liquid, which is formed by a pre-set percentage of a first liquid and a pre-set percentage of a second liquid established by the volumetric dosing device, is referred to by 1, 1′.

The volumetric proportional dosing device of the invention is particularly suitable for microdosing, i.e. it is able to reach dosing percentages between 0.005% and 0.025% (i.e. between 50 ppm and 250 ppm).

The proportional volumetric dosing device 1, 1′ has a (hydraulic) motor 20, driven by the flow of the first liquid flowing through the motor, and a second liquid delivery pump 25, 25′, which is fixed to and driven by the motor in order to deliver said second liquid.

In particular, the motor comprises an output shaft 31 to drive the pump. As will become clearer hereinafter, such output shaft is also part of the pump itself.

The motor 20 may comprise a tubular-shaped motor body 35 to which the pump is fixed and which is in fluid communication with the inlet duct 10 and the outlet duct 15.

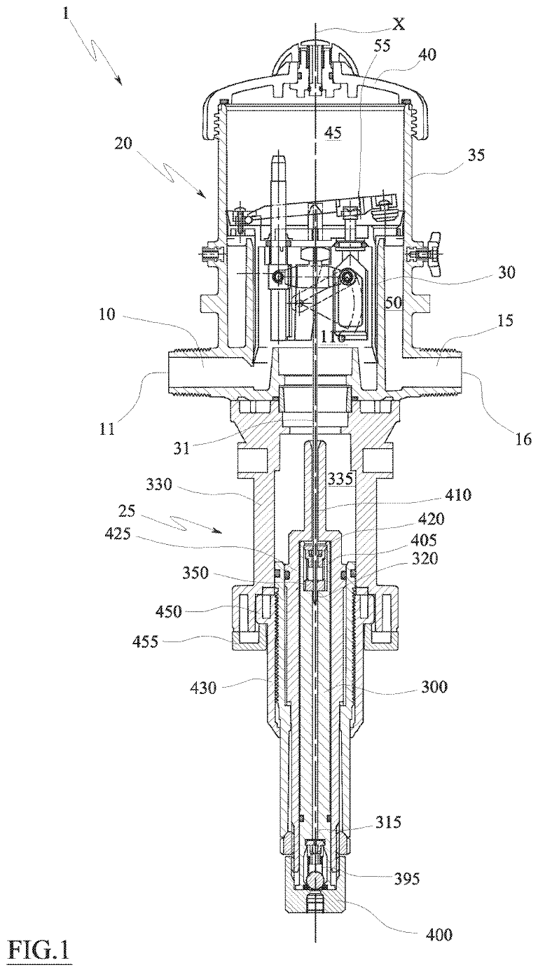

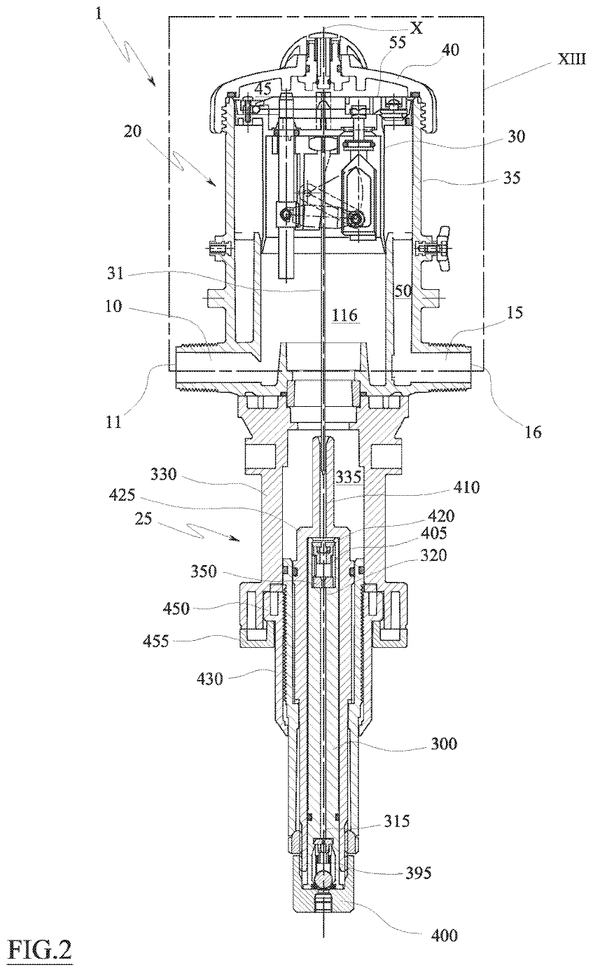

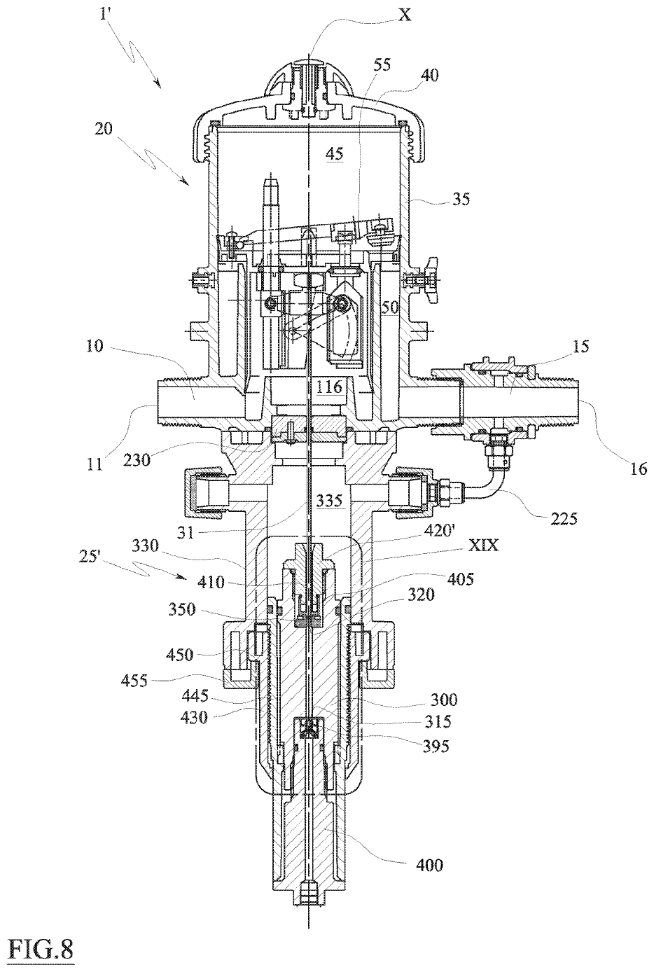

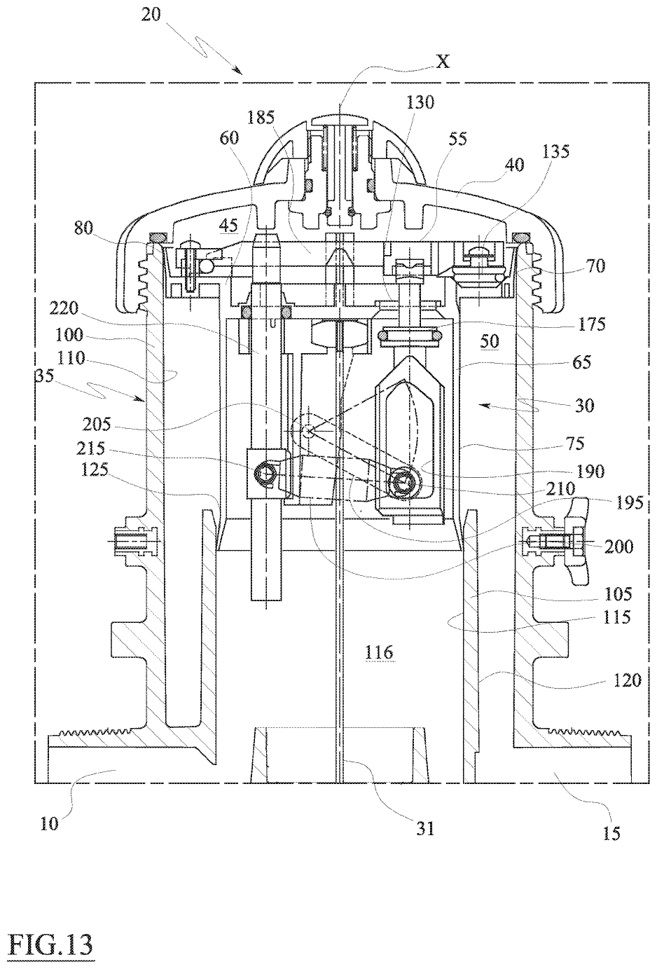

The motor may further comprise a piston 30 slidably housed in the motor body along a sliding axis X and which is moved along said sliding axis by the force generated by the flow of first liquid between a top dead centre position (abbreviated hereinafter as TDC and visible in the FIGS. 2 and 13) and a bottom dead centre position (abbreviated hereinafter as BDC and visible in FIGS. 1 and 8).

The output shaft 31 is coaxial to the sliding axis X, i.e., it is coaxial to the sliding axis X and extends longitudinally along said sliding axis, is integral in movement with the piston 30 between the bottom dead centre position and the top dead centre position (it is therefore also movable between a top dead centre position and a bottom dead centre position) and has a first axial end (always) connected (directly) to the piston and an opposite second free axial end (always) inserted inside the pump 25, 25′. In particular, the first axial end is fixed to the piston without residual degrees of freedom.

As will be described in more detail hereinafter, at least near the second free axial end, the output shaft 31 may comprise a side (cylindrical) surface, which extends from the second axial end towards the first axial end, is coaxial to the sliding axis X and has a constant transverse section (relative to a section plane perpendicular to the sliding axis X) along the entire extension of the side surface.

Such side surface belongs, for example, to a portion of the output shaft 31 that is entirely contained in the pump at least when said output shaft is at the BDC.

Preferably such side surface extends along the entire output shaft from the first end to the second end. Therefore the output shaft is basically shaped like a (cylindrical) rod. Preferably the second free end may be shaped as a rounded or blunt tip, e.g. it may be conical or truncated cone-shaped. This tip originates directly from the side surface.

The motor body 35 may comprise a cylinder within which the piston 30 is slidably inserted (to measure) along the sliding axis X. Such a cylinder thus has a central axis coaxial to the sliding axis X.

In addition, the motor body 35, at an end opposite to an end to which the pump is fixed, may be closed (at the top) by a lid (or cap) 40. In the top dead centre position the piston 30 is proximal to the lid and in the bottom dead centre position the piston 30 is distal from the lid.

Referring in particular to FIG. 13, said piston 30 may comprise a ceiling 55 (facing the lid), e.g. an upper ceiling.

The piston 30 is, for example, a differential-type piston, which therefore has a first cylindrical body 60, which makes available the ceiling 55, and a second cylindrical body 65 integral (without residual degrees of freedom) with the first cylindrical body sliding along the sliding axis X.

The second cylindrical body extends from a face of the first cylindrical body (to which the first end of the output shaft 31 is fixed and from which said output shaft 31 rises towards the pump) transverse to the sliding axis X and opposite to the ceiling 55, i.e. facing the pump, coaxially to the first cylindrical body and in the direction moving away from said face and from the ceiling 55 (towards the pump and in the direction moving away from the cap).

The second cylindrical body has a smaller diameter than the diameter of the first cylindrical body. In particular, the first cylindrical body comprises a cylindrical outer side surface 70 (coaxial to the sliding axis X) and the second cylindrical body comprises a cylindrical outer side surface 75 coaxial to that of the first cylindrical body (and extending from the face of the first cylindrical body opposite the ceiling) having a smaller diameter than a cylindrical outer side surface 70. Therefore, an annular surface opposite the ceiling is present, transverse to the sliding axis X and extending between an end of the cylindrical outer side surface 70 proximal to the second cylindrical body at an end of the cylindrical outer side surface 75 proximal to the first cylindrical body 60.

The second cylindrical body 65 is preferably a (thin-walled) cylindrical tubular body provided with a cylindrical outer side surface 75 and an opposite tubular inner side surface defining an inner axial cavity (arranged as concordant with the sliding axis X) of the piston in direct fluid communication with the inlet duct 10.

A portion of output shaft 31 proximal to the first axial end of the output shaft itself is contained in the inner axial cavity of the second cylindrical body.

When the cylinder is of the differential type, the motor body 35 comprises a first (outer) tubular body 100 comprising a cylindrical inner surface 110 which accommodates to measure (with a small clearance) the first cylindrical body 60 of the sliding piston guiding it along the sliding axis X, and a second (inner) tubular body 105 at least partially housed in the first tubular body 100 comprising a cylindrical inner surface 115 which accommodates to measure (with a small clearance) the second cylindrical body 65 of the sliding piston guiding it along the sliding axis X.

The cap 40 is fixed to the first tubular body by closing one end of the first tubular body distal from the pump.

At one end of the first tubular body opposite the cap, the first tubular body is joined to the second tubular body, e.g. near one end of the second tubular body proximal to the pump. The second tubular body 105, on the other hand, is spaced apart by a non-zero distance from the cap 40, such that it is not closed by the cap. In particular, the second tubular body 105 has a longitudinal extension along the sliding axis X that is smaller than a longitudinal extension of the first tubular body 100. In further detail, the second tubular body 105 has a minimum distance from the lid greater than the first tubular body (which, for example, directly contacts the lid).

The second tubular body 105 is internally coaxial to the first tubular body 100 relative to the sliding axis X and is dimensioned so that there is an annular gap between a portion of the inner cylindrical surface 110 of the first cylinder 100 and an outer (cylindrical) side surface 120 of the second tubular body. Such annular gap is in direct fluid communication with the outlet duct 15. By contrast, the inlet duct 10 is isolated from this gap, more specifically, this duct does not communicate directly with the gap.

Furthermore, the cylindrical inner surface 115 defines an axial cavity 116 in direct fluid communication with the inlet duct 10 and along which the piston, i.e. the second cylindrical body of the piston, slides. This cylindrical inner surface 115 is crossed by the inlet duct 10, while the cylindrical inner surface 105 of the first tubular body 110 is crossed by the outlet duct. The outlet duct does not intersect the second tubular body, so it does not communicate directly with the axial cavity 116.

The axial cavity 116 and the inner axial cavity of the first cylindrical piston body are always in direct fluid communication with each other. Consequently, the inner axial cavity of the first cylindrical piston body is always in direct fluid communication with the inlet duct 10. The axial cavity 116 is entirely crossed by the output shaft 31 and the second tubular body, at one end thereof proximal to the pump and distal from the lid 40, has an opening (which is never occluded by the piston) which is crossed by the output shaft, e.g. such opening has a diameter at least 4 times larger than a diameter of the output shaft, so that between the output shaft and the opening there is a large annular gap.

The first tubular body 100, i.e. its inner surface 110, together with the lid 40 and the first cylindrical body 60 of the piston delimits (entirely) a first chamber 45 of the motor, while the first tubular body 100, i.e. its inner surface 110, together with the first cylindrical body 60, the second cylindrical body 65 i.e. its outer surface 75, and the second tubular body 105, i.e. its outer surface 120, delimits (entirely) a second chamber 50 of the motor, wherein said chambers are separated from the piston and may be put in communication with each other (and with the cavity 116) as will be described in detail hereinafter.

A volume of the annular gap is part of the second chamber 50 (in particular, when the piston is at the bottom dead centre, the volume of the second chamber 50 corresponds to the volume of the gap).

The first chamber 45 is in indirect fluid communication with the inlet duct (as will become clearer hereinafter by means of appropriate valves and mechanisms for driving said valves) and the second chamber 50 is in direct fluid communication with the outlet duct. When the piston is at the top dead centre the volume of the first chamber 45 is minimum and the volume of the second chamber 50 is maximum, and at the bottom dead centre position the volume of the first chamber is maximum and the volume of the second chamber is minimum.

The cavity 116, the face of the first cylindrical body from which the second cylindrical body rises, and the inner cavity of the second cylindrical body of the piston (entirely) delimit a third chamber, which is in direct fluid communication with the outlet duct and in indirect fluid communication with the first chamber (and thus with the second chamber).

When the piston is at the top dead centre the volume of the third chamber is maximum, when it is at the bottom dead centre the volume of the third chamber is minimum.

The piston 30 has the ceiling 55, e.g. made available by the first cylindrical body (and facing the lid), and also has an annular sealing lip 80 which rises from the ceiling of the piston (or from the cylindrical outer side surface 70 of the first cylindrical body 60, or from both), in particular which rises from an outer annular perimeter edge of the ceiling of the piston, and which insists in contact on the cylinder of the motor body, i.e. on the inner cylindrical surface 110 of the first tubular body, creating a fluidic sealing between the first chamber and the second chamber. If the annular sealing lip were not present, the fluid could flow sideways to the piston in the gap between the cylinder and the piston due to the coupling clearance between said two elements.

The annular sealing lip 80 is in contact with the cylinder at least along a continuous circumference, i.e. without interruption. Preferably it is in contact therewith along a continuous cylindrical surface.

The piston 30 may comprise a further annular sealing lip 125, substantially shaped in a similar way to the annular sealing lip 80 which slides in contact with the cylindrical inner surface 115 of the second cylinder 105 so as to create a fluidic sealing separating the axial cavity 116 of the second cylindrical body from the second chamber 50.

The volumetric dosing device may comprise an elastic element which pushes the annular sealing lip 80, i.e. the (free) end portion of the annular sealing lip against the cylinder, i.e. the first cylinder 100, even more specifically against the inner cylindrical surface 110 of the first cylinder 100.

The axial cavity of the second cylinder 105, i.e. the third chamber, is in communication with the outlet duct 15 by a valve system. In particular, the axial cavity of the second cylinder 105, i.e. the third chamber, is in communication with the first chamber (only) by at least one valve and the first chamber is in communication with the second chamber (only) by a second valve.

For a detailed description of such valve system, please refer to document US201916423366, which is incorporated herein for reference purposes.

Referring in particular to FIG. 13, the valve system comprises at least one inner valve 130 and one outer valve 135 wherein the expression inner valve means a valve proximal to the sliding axis X along a radial direction and the expression outer valve means a valve radially further away from the sliding axis X than the inner valve.

The inner valve 130 is interposed between the axial cavity of the second cylindrical body 65 and the first chamber 45, i.e. between the third chamber and the first chamber, and, for example, comprises a shutter 175 adapted to be engaged in a relative valve seat 180 made in the first cylindrical body 65, at a through hole (parallel and eccentric to the sliding axis X) which places the axial cavity of the second cylindrical body in fluid communication with the first chamber 45.

The outer valve 135, on the other hand, controls the opening and closing of a through hole made in the first cylindrical body, which places the first chamber 45 in fluid communication with the second chamber 50. The outer valve comprises a shutter adapted to be engaged in a valve seat made at this through-hole.

The valves are associated with a rocker arm 185 that is jointed, at one end, to the ceiling of the piston so as to perform small oscillations, about a joint pin thereof, alternatively between a first position, wherein the inner valve 130 is closed and the outer valve 135 is open, and a second position, wherein the inner valve is open and the outer valve is closed. In particular, the inner valve 130 is constrained to the rocker arm by a portion thereof, so that when the rocker arm rotates from the second to the first position, the portion of the inner valve 130 is moved upwards and causes the shutter to close the valve seat.

By contrast, the shutter of the outer valve 135 is directly supported by the rocker arm and the rocker arm, by rotating from the second to the first position, brings the shutter to a position distal from the valve seat, opening the corresponding outer valve 135.

The movement of the rocker arm, which determines the respective opening and closing positions of the inner and outer valves, is entrusted to a spring drive mechanism.

In the embodiment shown the spring drive mechanism is configured to be engaged in a slot 190, provided with a lower surface and an upper surface, e.g. opposite to each other and aligned along a direction parallel to the sliding direction X, obtained in a shutter body 175 of the inner valve.

Such spring drive mechanism comprises a pair of connecting rods 195, where each connecting rod is associated with a respective spring 200.

Each connecting rod is fixed to a respective hinge 205 placed on the piston 30 and, through a hinge 210, which is housed in the slot 190, at a first end of the respective spring 200.

In turn the springs 200 are fixed in a second end thereof to a hinge 215 placed on a rod 220 slidably associated with the piston 30 i.e. that is constrained to the piston 30 so as to be able to translate relative to the piston itself.

In particular, the rod 220 can slide vertically inside a through hole 26a obtained in the body of the piston 30 itself.

Furthermore, the rod 220 has a raised element constrained to slide within a guide 52 of the piston 30 that terminates at one end with a lower abutment element and at the opposite end with an upper abutment element, where said abutment elements can alternatively engage with the raised element of the rod to determine the respective stroke ends thereof along the translation axis of the rod, an axis which is parallel to the sliding axis X.

The position of the rod 220 in relation to the piston 30 determines the driving of the spring drive mechanism and regulates the upward and downward stroke of the piston.

The pump 25 which, as mentioned, has the function of supplying a second liquid to the motor is fixed underneath the motor body 20.

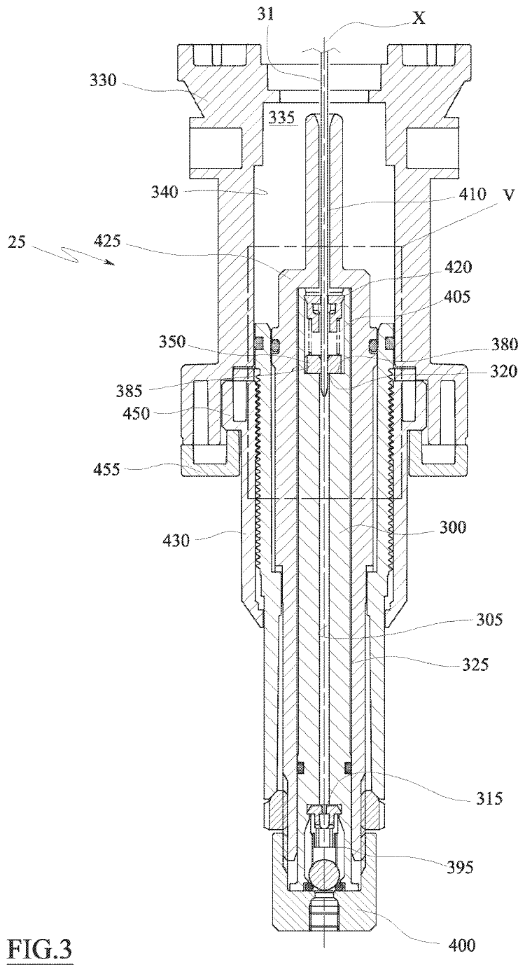

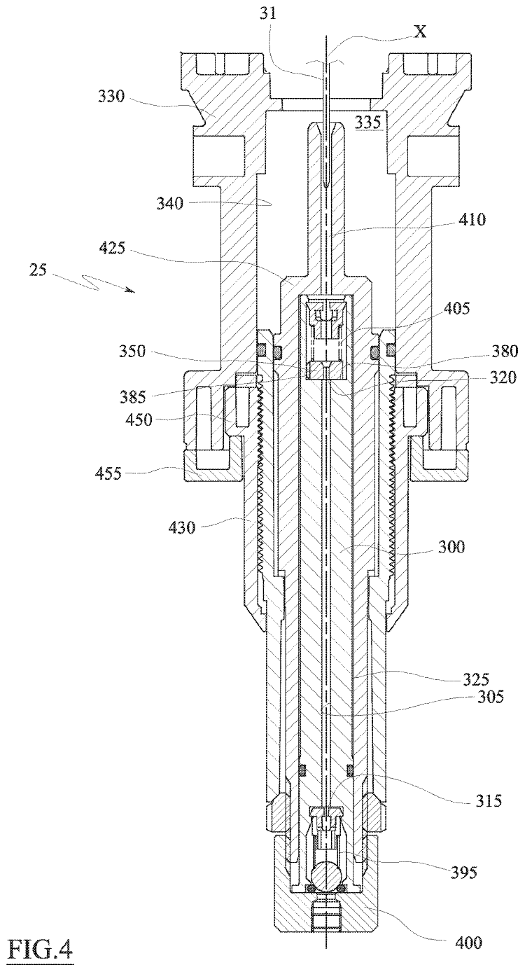

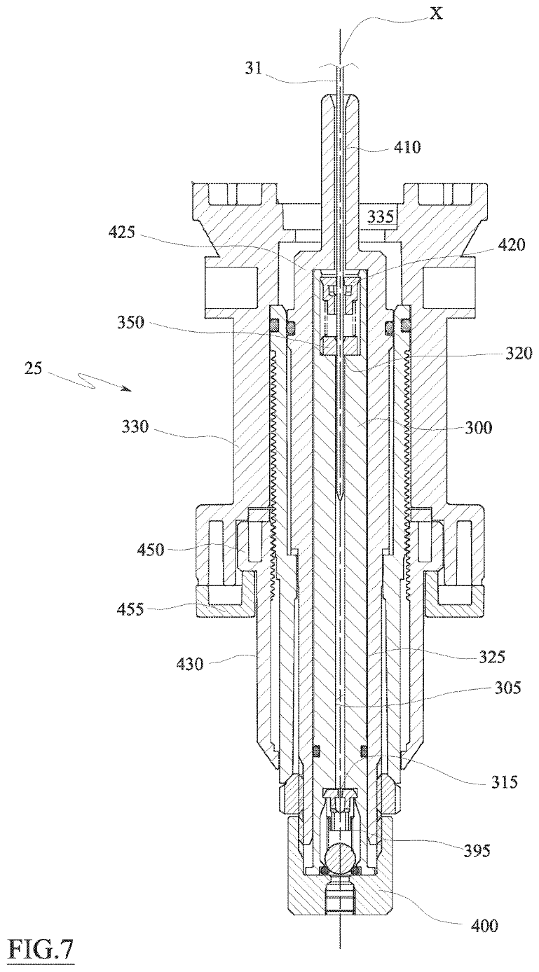

Two embodiments of volumetric dosing device are shown in the Figures, one of which, referred to by 1′ (FIG. 8), is provided with a by-pass duct 225 fluidically interposed between the pump 25′ and the outlet duct 15, into which the second fluid is pumped to mix with the first fluid in the outlet duct 15. When such by-pass is not present, the second liquid is pumped into the cavity 116, i.e. into the third chamber, as in the case of the dosing device 1 in FIGS. 1-7 and 13.

In further detail, in the embodiment 1 shown in FIGS. 1-7 and 13 the opening of the second tubular body 110 proximal to the pump 25 is free and is in fluid communication with the pump, while in the embodiment 1′ shown in FIG. 8 in which the by-pass 225 is present, this opening is closed by a plug 230 provided with a through-hole into which the output shaft 31 slides to measure, which through-hole includes a housing seat for a (dynamic) sealing gasket which sealingly insists on the output shaft 31.

Regardless of how the second liquid pumped by the pump reaches the motor, said pump 25, 25′ comprises a (rigid) tubular body 300, e.g. cylindrical, coaxial to the output shaft 31 and which comprises a (cylindrical) inner tubular surface 305 coaxial to the output shaft 31. A portion of the output shaft starting from the second end of the output shaft itself, when said output shaft is at (near) the BDC, is housed entirely in an inner volume of the tubular body (partially) defined by the inner tubular surface 305.

Such inner volume together with the output shaft 31 at least partially defines a pumping chamber 310, and in its movement between the TDC and the BDC, the output shaft variably occupies the inner volume of the tubular body 300, thereby varying the extent (the value/dimension) of the pumping chamber 310. In particular, when the output shaft 31 is at the BDC the pumping chamber 310 has a minimum extension and when the output shaft 31 is at the TDC the pumping chamber 310 has a maximum extension. As will become clearer hereinafter, at the TDC the output shaft can be totally outside the inner volume of the inner tubular surface 305.

For example, the inner tubular surface 305 has a diameter lower than 5 mm (and possibly higher than 0.1 mm). In the embodiment shown, the diameter of the tubular surface is between 2.75 mm and 3.75 mm. The output shaft, at least in the section inserted into the inner tubular surface 305 has a diameter between 1.75 mm and 2.25 mm.

Regardless of the exact size of the diameter of the surface 305, and of the output shaft 31, the inner tubular surface 305 preferably has a passage section (transverse, i.e. perpendicular, to the sliding axis X) such that the output shaft 31 is inserted therein with a small clearance, and when it is inserted, there is a non-zero-sized (annular) gap between the side surface of the output shaft and the inner tubular surface 305, a gap into which the second liquid can flow. For example, such gap has a minimum thickness, i.e. the minimum distance between the side surface of the output shaft and the inner tubular surface 305, of between 0.5 mm and 0.75 mm.

The tubular body 300 comprises a first longitudinal end, distal from the motor, near or at which the inner tubular surface 305 makes available an inlet port 315 of the second liquid to be pumped, and an opposite second longitudinal end, proximal to the motor, and near or at which the inner tubular surface makes available an outlet port 320 of the second liquid.

Between the outlet port and inlet port of the tubular body, the inner tubular surface 305 has a constant cross-section along the entire extension of the surface 305 along the sliding axis X.

The inner tubular surface 305 is, for example, continuous without interruption along its entire extension, in particular, there are no holes in the tubular body 300 at the inner tubular surface 305 passing through the inner tubular surface transverse to the sliding axis X and placing the inner volume in connection with an outer environment.

The tubular body may comprise an outer (cylindrical) tubular surface 325 opposite to the inner tubular surface, e.g. coaxial to the sliding axis X, which is distant by a non-zero distance from the surface 305 defining a (non-zero) thickness of the tubular body itself. The pump then comprises a (tubular and rigid) sleeve 330 coaxial to the output shaft 31, i.e. to the sliding axis X, which connects the tubular body 300 to the motor, i.e. to the motor body 35. For example, the sleeve 330 comprises a portion thereof fixed, by means of threaded members, to the motor, i.e. to the motor body 35. In particular, the sleeve is fixed to the motor body 35 at a side opposite to the lid 40.

The sleeve 330 defines an inner volume 335, inside the sleeve 330 itself, in fluid communication with the outlet port 320 of the second liquid, i.e. with the inner volume of the tubular body 300, i.e. with the pumping chamber 310.

The tubular body 300 is partially housed in such inner volume 335. In particular, the sleeve comprises an inner (cylindrical) tubular surface 340 that defines the inner volume 335. The inner volume 335 is delimited at one end of the sleeve by the tubular body and at an opposite end

Said inner volume 335, depending on the embodiment of the dosing device with or without by-pass, may be in direct fluid communication either with the axial cavity 116, or with the third chamber of the motor, for example by means of the opening of the second tubular body 110 proximal to the pump, or it may be in direct fluid communication with the bypass duct 225, which creates an inlet opening in said sleeve, i.e. in the inner tubular surface 340 thereof. In the latter case, the inner volume of the sleeve 330 is partially delimited by the plug 230 which closes the opening of the second tubular body 110.

The sleeve is substantially shaped as a tubular body from one end fixed to the motor to an opposite end and its inner tubular surface has a diameter at least greater than the diameter of the outer tubular surface 325 of the tubular body 300.

The pump 25, 25′ comprises an annular sealing gasket 350, 350′ crossed by the output shaft, i.e., a section of the output shaft 31, in its movement between the BDC and the TDC, which creates a (hermetic) fluidic sealing on the output shaft 31, and which, together with the output shaft 31, when the latter crosses the annular gasket, is adapted to occlude the outlet port 320.

Said section of the output shaft extends between a point of the output shaft contacting the gasket 350, 350′, when the shaft is at the BDC, and a point proximal to the second end contacting the gasket 350, 350′ when it is at the TDC or the second end of the output shaft in case, at the TDC, the output shaft is external to the tubular body 300 and not inserted into the annular sealing gasket.

In particular, said section of the output shaft may comprise all or part of the portion of the output shaft contained within the inner volume of the tubular body 300 when said shaft is at the BDC.

Preferably, the tubular body 300 is placed at a distance from the motor body, and the output shaft has an axial extension, such that, when the output shaft is at the TDC, it is totally outside the inner volume of the tubular body and does not cross the annular sealing gasket 350, 350′. In this situation, therefore, the outlet port 320 of the tubular body 300 is always in free and direct fluid communication with the inner volume of the sleeve, as the shaft does not create a sealing with the annular sealing gasket.

The annular sealing gasket 350, 350′ is preferably elastic, i.e. it may be elastically deformed, under the normal working stresses to which it is subjected, in particular it may be deformed in the area where the output shaft is inserted therethrough, in order to generate a thrust on the output shaft that creates the fluidic sealing on it.

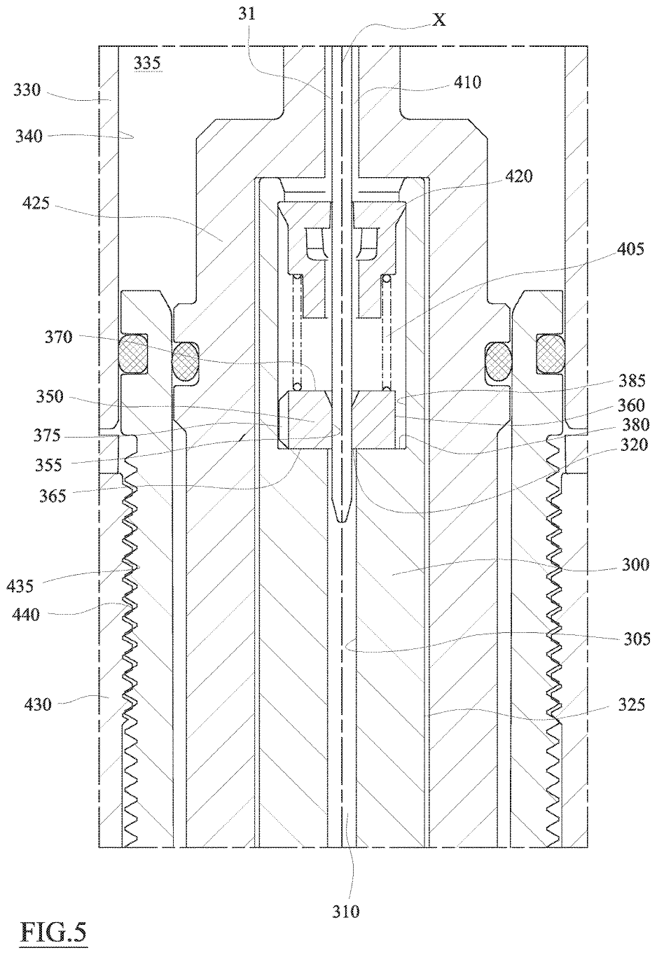

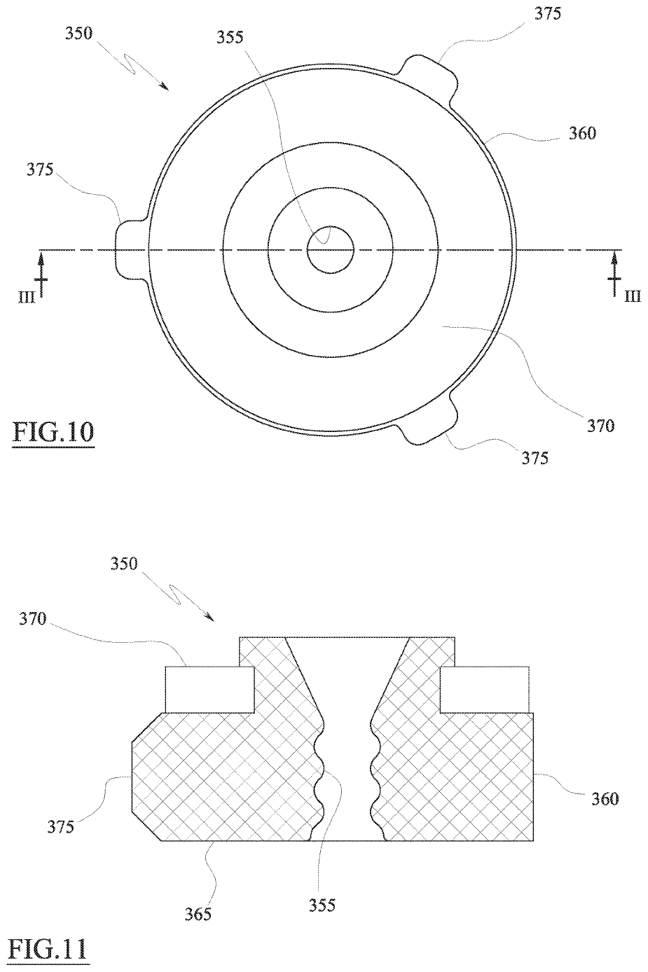

Referring in particular to FIGS. 5, 6, 9-12, the annular sealing gasket 350, 350′ comprises an inner (tubular) annular surface 355 (substantially defining a through-hole coaxial to the sliding axis X) in which said section of the output shaft is inserted to measure and sealingly (in other words, the inner annular surface 355 sealingly encloses the section of the output shaft sliding therethrough). As mentioned above, at least at the inner annular surface 355 the gasket is elastic and may be elastically deformed.

Preferably, at rest, i.e. when the output shaft 31 is not inserted in the inner annular surface 355, in order to achieve a fluidic sealing on the output shaft, such inner annular surface 355 has a diameter smaller than a diameter of the section of the output shaft inserted in the annular sealing gasket 350, 350′, i.e. smaller than a diameter of the side surface of the output shaft at said section.

The inner annular surface 355 (even when the shaft is inserted into it by expanding it) may have a smaller diameter (measured perpendicular to the sliding axis) than the diameter of the inner tubular surface 305 at the outlet port 320. Consequently, when the annular sealing gasket 350, 350′ occludes the outlet port 320 together with the output shaft, the second liquid present in the inner volume, i.e. in the pumping chamber 310, can push on an annular surface of the annular sealing gasket 350 around the inner annular surface 355 and which extends from said inner annular surface.

The inner annular surface 355 may be corrugated so as to make a plurality of annular lips in series with each other along the sliding axis X, each of which contacts part of said section of output shaft 31 along a respective circumference transverse (perpendicular) to the sliding axis X.

The annular sealing gasket 350, 350′ comprises an outer (tubular) annular surface 360, e.g. cylindrical, opposite to the inner annular surface 355 and preferably coaxial to the sliding axis X.

The annular sealing gasket 350, 350′ further comprises a first face 365, e.g. plane, preferably perpendicular to the sliding axis X, which connects the inner annular surface 355 to the outer annular surface 360 and a second face 370, e.g. plane, preferably perpendicular to the sliding axis X, opposite to the first face, which connects the inner annular surface and the outer annular surface on one side of such surfaces opposite to the first face.

The first face 365 makes available the annular surface of the annular sealing gasket 350, 350′ which is (externally) located about the inner annular surface 355 and which has a smaller diameter than the diameter of the inner tubular surface 305 at the outlet port 320. At the second face 370, the inner annular surface 355 has an enlarged guiding portion adapted to ease the entry of the second longitudinal end of the output shaft into the annular sealing gasket.

The annular sealing gasket 350, 350′ shown is, for example, a cylindrical body, preferably disc-shaped, in which a through-hole defining the inner annular surface 355 is made.

In the embodiment of the annular sealing gasket 350 shown in FIGS. 1 to 11, such a gasket comprises a plurality of (equal) protrusions 375, e.g. three in number, extending radially from the outer annular surface 360 in the direction moving away from it. For example, such protrusions are angularly equally spaced from each other in relation to the sliding axis X.

It is also not excluded that in an alternative embodiment not shown, the protrusions could extend from the second face 370.

Furthermore, in an alternative embodiment not shown, in place of the protrusions, there could be at least one hole, preferably a plurality of holes, passing through the annular sealing gasket 350 from the first face to the second face (faces included). Such holes must be eccentric and more distant from the rotation axis than the annular surface of the first face 365 which is (externally) around the inner annular surface 355 and which has a smaller diameter than the diameter of the inner tubular surface 305 at the outlet port 320. In all cases, two protrusions adjacent to each other substantially form a groove (radial to the sliding axis X) in the annular sealing gasket, at the outer annular surface of the annular sealing gasket, which groove extends parallel to the sliding axis and is adapted to place in fluid communication an environment, which the first face of the annular sealing gasket is facing, with an environment which the second face of the annular sealing gasket is facing. The plurality of protrusions thus forms a plurality of grooves in the annular sealing gasket at the outer annular surface of the annular sealing gasket, which extend parallel to the sliding axis and are adapted to place in fluid communication an environment, on which the first face of the annular sealing gasket is facing, with an environment, on which the second face of the annular sealing gasket is facing.

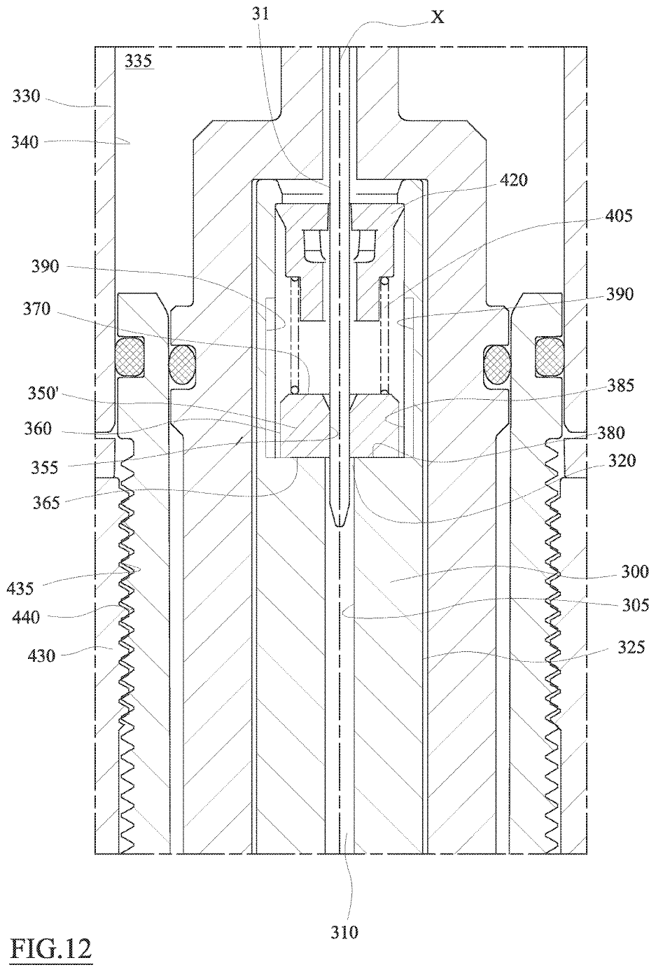

In the embodiment of the annular sealing gasket 350′ shown in FIG. 12, such protrusions are not present and the outer annular surface 360 comprises at least one cylindrical section that performs an entire revolution about the sliding axis X.

The tubular body 300 comprises a housing seat of the annular sealing gasket 350, 350′ (coaxial to the sliding axis X) made near or at the second end in the tubular body 300 and at the outlet port 320 of the second liquid. The housing seat is in fluid communication (direct and always) with the inner volume of the sleeve and is crossed by said section of the output shaft 31.

Such housing seat is, for example, substantially made as an enlarged continuation of the inner tubular surface 305 extending to the second end of the tubular body 300.

In the embodiment shown, the housing seat comprises a (plane) abutment surface 380 which originates from the inner tubular surface 305 of the tubular body 300 in the direction moving away from the sliding axis X and transverse (perpendicular) thereto, e.g. such abutment surface is annular, preferably shaped as a circular crown.

The housing seat also comprises a side surface 385 (tubular, e.g. cylindrical), which is coaxial to the sliding axis X and extends from the abutment surface 380, i.e. from a peripheral edge of the abutment surface 380, transverse to the abutment surface, e.g. parallel to the sliding axis X, preferably moving closer to the motor.

The housing seat, i.e. its side surface 385, creates in the second end of the tubular body 300 an access port (crossed by said section of the output shaft) to the outlet port 320 and which is in fluid communication with the inner volume of the sleeve.

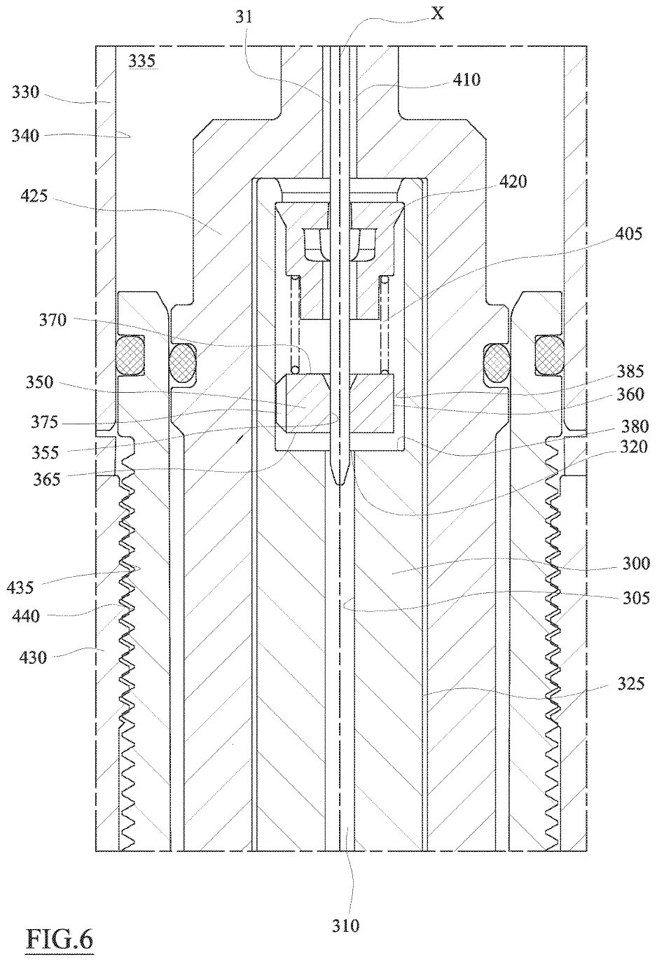

The housing seat and the annular sealing gasket must be shaped in such a way as to create a hermetic sealing along at least one closed-loop circular surface when the annular sealing gasket is housed in the housing seat. For example, the hermetic sealing is obtained by an annular portion, e.g. contiguous to the annular portion on which the second liquid pushes, of the first face of the annular sealing gasket when said first face is in contact with the abutment surface. FIG. 6 shows in particular an operating condition of the pump wherein the annular sealing gasket 350 is not sealingly housed in the housing seat and does not create a hermetic sealing with it. In detail in such figure, the first face 365 is spaced apart from the abutment surface 380.

It cannot be excluded that in an embodiment not shown, the outer annular surface (with possibly also a section of the first face) may create a hermetic sealing with the side surface 385 of the housing seat. In such a case, the annular sealing gasket would not comprise grooves (in fact, it must not comprise them otherwise there would be no sealing on the side surface), i.e. it does not comprise the protuberances, and the housing seat comprises, instead, at a portion of the side surface 385 downstream (with respect to the direction of the second liquid from the inner volume of the tubular body to the inner volume of the sleeve) of the portion of the side surface 385 which creates a hermetic sealing with the annular sealing gasket, a groove furrowing the side surface 385, i.e. it comprises a plurality of grooves (radially equally spaced about the sliding axis X) furrowing said side surface.

As an alternative or in addition to the grooves, or holes, in the annular sealing gasket, the housing seat may comprise a groove 390, preferably a plurality of grooves 390, which place in fluid communication the inner volume of the tubular body with the inner volume of the sleeve, when the annular sealing gasket is not housed in the sealing housing seat, i.e. when the first face of the annular sealing gasket does not sealingly contact the abutment surface of the housing seat.

For example, said grooves 390 mainly extend along respective longitudinal axes parallel to the sliding axis X and have a minimum extension along said longitudinal axes greater than the maximum extension in the same direction of the outer annular surface 360 (possibly greater than the maximum extension in that direction of the distance between the first face and the second face of the annular sealing gasket).

In the embodiment of FIG. 12, the annular sealing gasket does not have the grooves whereas the grooves 390 are present on the side surface 350.

In both cases, when the annular sealing gasket is not sealingly housed in the housing seat, i.e. the portions thereof that create a hermetic sealing with the housing seat do not contact the housing seat and are spaced apart therefrom (as, for example, exemplified in FIG. 6), the grooves (those made in the housing seat, i.e. in the side wall 385, or those that substantially create the protuberances in the annular sealing gasket) and/or the through holes (not shown), and/or a (radial) clearance present between the outer annular surface of the annular sealing gasket and the side wall 385, allow for a fluidic connection between the inner volume of the tubular body, i.e. the pumping chamber, and the inner volume of the sleeve (in particular with the access opening made in the second end of the tubular body from the housing seat).

Furthermore, the radial clearance between the outer annular surface of the annular sealing gasket and the side surface 385, which substantially defines an annular-shaped gap between the outer annular surface and the side surface 385, is preferably also present when holes and/or grooves (in the gasket and/or housing seat) are present. Such gap is for example continuous and encloses the entire annular sealing gasket, i.e. the gap has such an extension that the outer annular surface (and not even the protrusions) of the annular sealing gasket does not touch the side surface 385. Thereby, when the annular sealing gasket is not sealingly housed in the housing seat, i.e. when the first face is not in sealing contact with the abutment surface, the second liquid can flow into said gap towards the inner volume of the sleeve (regardless of the use of grooves and holes). The use of the grooves (in the gasket and/or housing seat) and/or of passage holes in addition to the annular gap makes it possible to maintain a section that is sufficient for the passage of the second liquid and, at the same time, makes it possible to reduce the size of the gap, thus reducing the clearance relative to the housing seat, so as to avoid gasket entrapment and jamming.

At an end opposite to the housing seat of the annular sealing gasket 350, 350′, the pump may comprise a one-way valve 395, e.g. of the automatic type (governed by the difference in pressures), which governs the passage of the second liquid through the inlet port 315 only allowing the flow to enter the inner volume, i.e. the pumping chamber, and not to exit therefrom. This one-way valve 395 is thus movable between an open position, wherein it allows the second liquid to enter the inner volume, and a closed position, wherein it isolates and closes the inlet port 315.

For example, the tubular body 300 comprises a housing seat for such a one-way valve 395, which is made at the first end and in fluid communication with the inlet port 315. Preferably, the pump also comprises a plug 400 which may be removably fixed to the tubular body 300, e.g. the plug comprising a threaded surface to be screwed onto a threaded surface of the tubular body 300, which holds the one-way valve 395 in the respective seat. Such plug 400 comprises a through-hole in fluid communication with the pumping chamber when the one-way valve 395 is open.

In the embodiment shown, the one-way valve 395 comprises a shutter acting on said through-hole and a spring located in abutment of the housing seat and pushing the shutter into the closed position of the through-hole.

The plug 400 then comprises means, such as threaded or quick-release means, connecting a pipe for conveying the second liquid to the through-hole.

It is not excluded that in an alternative embodiment not shown, the one-way valve may be part of a pipe provided with an end connected to the inlet port 315.

The inner tubular surface 305, together with the annular sealing gasket 350, 350′, the one-way valve 395 and the output shaft 31 (and the housing seats for the annular sealing gasket and the one-way valve respectively) define the volume of the pumping chamber. The pump comprises a pushing device, for instance elastic, preferably a spring 405, which generates (constantly) a thrust on the annular sealing gasket 350, 350′ in particular by acting (directly) on the second face, (only) in a direction (parallel, i.e. coaxial, to the sliding axis X) for keeping the annular sealing gasket in contact with the housing seat, thereby achieving a hermetic sealing with it (along at least one annular closed-loop surface, whether between the first face and the abutment surface or).

The pushing device preferably generates a thrust on the annular sealing gasket, such that the annular sealing gasket is kept in the housing seat and the hermetic sealing is generated, when the output shaft 31 moves from the BDC to the TDC. In particular, the force generated by the thrust of the pushing device on the annular sealing gasket is greater than the drag force exerted by the output shaft on the annular sealing gasket as it moves from the BDC to the TDC, due to the friction between the output shaft and the inner annular surface of the annular sealing gasket.

The thrust generated by the pushing device must then not be excessive, since when the output shaft 31 moves from the top dead centre to the bottom dead centre and is inserted in the inner annular surface of the annular sealing gasket, the force of the pushing device, i.e. of the spring, must be able to be overcome by the second liquid, which, as it is not able to exit the pumping chamber through the inlet port due to the one-way valve, by pushing on the annular sealing gasket, i.e. on the annular surface of the first face having a smaller diameter than the outlet port, must be able to overcome the force of the pushing device, for instance compressing the spring, in order to move the annular sealing gasket away from the seat.

In the embodiment shown, the pushing device comprises only the coil, preferably compression, spring 405.

It is not excluded that in an alternative embodiment not shown, the pushing device could be electro-actuated or hydraulically actuated, in which case it would act on the annular sealing gasket only when the shaft moves from the BDC to the TDC.

In the embodiment shown, the spring 405 exerts a thrust on the annular sealing gasket in a direction parallel to the sliding axis, i.e. the spring is coaxial to the sliding axis and is crossed (entirely) by the output shaft 31.

As a result of the action of the pushing device on the annular sealing gasket, the movement of the piston and the fact that the liquid cannot be compressed, the annular sealing gasket 350, 350′ is movable, according to a balance (difference) of forces acting thereon, which balance is a difference between a pressure in the inner volume of the tubular body 300, i.e. in the pumping chamber, the force exerted by the pushing device (which is contrary to the pressure in the pumping chamber) and the drag force due to the output shaft 31 sliding in the inner annular surface of the annular sealing gasket 350, 350′ as it moves from the TDC to the BDC (which is contrary to the pressure in the pumping chamber). In particular, when the pressure in the inner volume increases, it is opposed by the thrust generated by the pushing device.

According to this balance, the sealing gasket is movable between a closed position, in which it creates a hermetic sealing with the housing seat and the inner volume of the tubular body 300, i.e. the pumping chamber, is isolated from the inner volume of the sleeve (the outlet port 320 is closed by the output shaft 31 and the annular sealing gasket, in particular by its first face) and an open position, in which the annular sealing gasket is at least partially spaced from the housing seat and the inner volume of the tubular body, i.e. the volume of the pumping chamber, is in communication with the inner volume 335 of the sleeve (the outlet port is free from the annular sealing gasket, it may possibly still be partially occupied by the outlet shaft). As a further detail, in the open position at least the annular portions, of the annular sealing gasket and the housing seat, which together create the hermetic sealing under the force of the pushing device, are spaced apart from each other. That is, when the annular portion of the first face is spaced out (not in contact) from the annular portion of the abutment surface with which it creates the hermetic sealing, or when the portion of the outer annular surface is spaced out (not in contact) from the portion of the side surface of the housing seat with which it creates the hermetic sealing, the annular sealing gasket is in the open position.

In order to reduce the stagnation of the second liquid near the outlet port 320, at the second axial end of the tubular body (on one side of the housing seat opposite the abutment surface), there is an anti-stagnation duct 410 (straight and coaxial to the sliding axis X), which is crossed by the output shaft and extends in the direction moving closer to the motor. Such duct 410 has a smaller diameter than the housing seat of the annular sealing gasket, in particular smaller than the side surface 385, thus creating a narrow portion of the housing seat. The output shaft 31 is then slid through said duct 410 with a clearance, e.g. the same clearance existing between the output shaft 31 and the inner tubular surface 305 (annular gap between them having a thickness lower than one millimetre, e.g. between 0.5 mm and 0.75 mm). Such a clearance is substantially constant along the entire extension of the duct 410.

However, it cannot be excluded that the clearance could be greater, but in any case the duct must have a smaller cross-section than the cross-section of the housing seat, i.e. the side surface 385, in relation to a section plane perpendicular to the sliding axis X. The smaller the diameter of the duct 410, as long as it allows the output shaft to pass through, the greater the achievable “injector” effect that sprays the second liquid into the inner volume of the sleeve.

The anti-stagnation duct comprises an inlet port, proximal to the outlet port 320 and distal from the motor, and an opposite outlet port, distal from the outlet port 320 and proximal to the motor.

Both of said ports are crossed by the output shaft 31 and preferably the duct 410 has substantially the same cross-sectional area (relative to the sliding axis X), possibly with a maximum variation tolerance of 20%, from the inlet port to the outlet port. In the embodiment shown, the duct 410 comprises a straight cylindrical surface with a constant section from the inlet port to the outlet port.

The longitudinal extension of the duct 410 (to be understood as the distance of the inlet port from the outlet port) is for example between 5 and 35 times the diameter of the output shaft near the second free end, preferably between 10 and 20 times.

The annular sealing gasket 350, 350′ is interposed between the abutment surface of the housing seat and said inlet port, i.e. the annular sealing gasket 350, 350′ and the pushing device are interposed between the abutment surface of the housing seat and said inlet port.

The pump may comprise a holding body 420, 420′ adapted to keep the pushing device in position, i.e. to keep the spring of the pushing device pre-compressed and in position, and rigidly associated with the tubular body 300. In the case shown of the spring, it thus comprises a first longitudinal end in (direct) contact with the holding body and a second longitudinal end in (direct) contact with the second face of the annular sealing gasket.

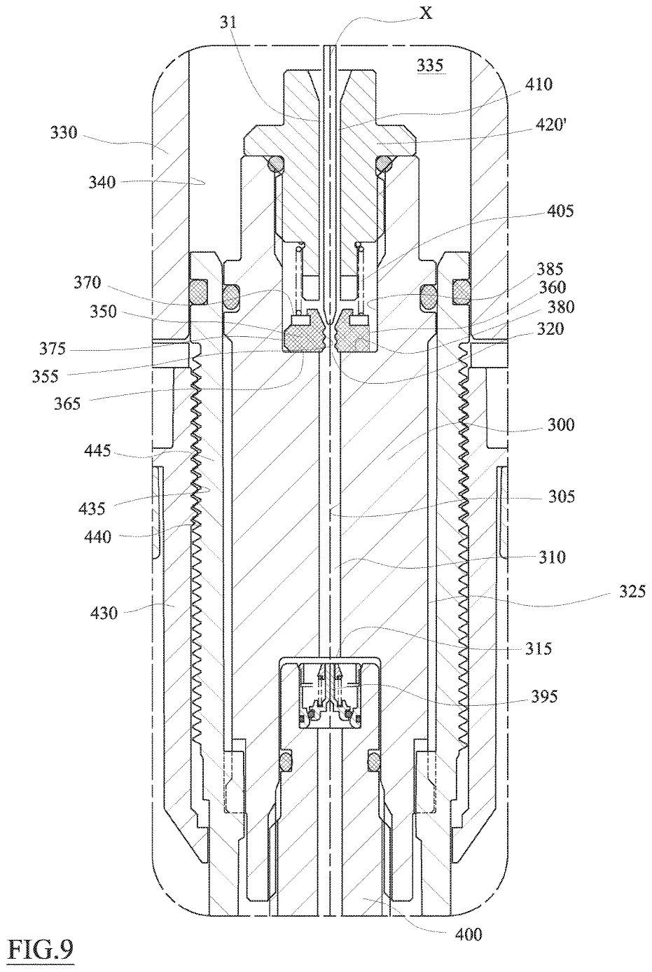

The holding body 420′ may be removably fixed (e.g. by means of a threaded connection) to the tubular body 300, as in the embodiment of FIGS. 8 and 9, or, as it happens in the embodiment of the Figures, the holding body 420 may be non-removably fixed (e.g. by plastic deformation of the tubular body 300).

In both cases, the holding body 420, 420′ partially closes the opening that the housing seat of the annular sealing gasket creates in the second end of the tubular body 300. The holding body 420, 420′ may then be regarded as a plug provided with the through-hole and partially closing said housing seat.

The holding body 420, 420′ has a through-hole crossed by the output shaft 31. For example, a volume of the housing seat of the annular sealing gasket 350, 350′ is in fluid communication with the inner volume of the sleeve by said through-hole of the holding body. In particular, the through-hole of the holding body is substantially the only way by which the second pumped liquid can move away from the housing seat. In the embodiment shown, the volume of the housing seat of the annular sealing gasket 350, 350′ is in fluid communication with the inner volume of the sleeve (only) by said through-hole of the holding body and the anti-stagnation duct 410.

The holding body 420′ can make available the anti-stagnation duct 410 as a continuation of its own through-hole. In particular, in such a case, on one face of the holding body 420′ opposite the annular sealing gasket, a tubular body rises, moving closer to the motor which makes available the duct 410. Although this configuration of the anti-stagnation duct is shown only for the holding body 420′, nothing excludes that it could also be applied to the holding body 420.

If the holding body 420′ is removably fixed, it may comprise a tang, inserted inside the spring and provided with a groove, i.e. an annular groove, in which a turn of the spring is inserted and retained at the first longitudinal end of the spring, so that when removing the holding body from the tubular body 300, the spring can also be removed.

Both the hole of the holding body crossed by the output shaft 31 and the anti-stagnation duct do not include any gasket that insists on a portion of said shaft inserted therein.

In case the holding body is non-removably (permanently) fixed, the tubular body 300 is inserted into a containment tubular body 425, and is held therein by means of the plug 400, which in this case is screwed to the containment tubular body 425 by fitting the tubular body between the plug and a bottom wall of the containment tubular body opposite the plug 400.

In particular, the containment tubular body 425 comprises a first longitudinal end that is distal from the motor, which has an opening into which the tubular body 300 can be inserted (to measure), and an opposite second longitudinal end, that is proximal to the motor and housed in the inner volume of the sleeve, which has a bottom wall on which the second end of the tubular body 300 or the holding body abut.

The tubular body 300 is then clamped between the bottom wall and the plug 400.

The bottom wall is holed (only) to allow for the passage of the output shaft 31, and the anti-stagnation duct 410 is made available by the tubular containment body 425 and extends from the back wall.

The containment tubular body 425 comprises an inner (cylindrical) tubular surface, into which the outer tubular surface of the tubular body 300 is inserted (to measure), and an opposite outer (cylindrical) tubular surface, which extend from the bottom wall to the first longitudinal end of the containment tubular body itself.

Between the inner tubular surface of the containment tubular body 425 and the outer tubular surface of the tubular body 300, an annular sealing gasket is preferably interposed, for instance positioned in a section between the non-return valve and the second end of the tubular body 300.

The tubular body 300 may be movably associated to the motor, i.e. to the sleeve 330, slidably along the sliding axis X, and for instance, the pump 25, 25′ may comprise a mechanism for varying the position of the tubular body 300, configured to allow the sliding of the tubular body 300 along the sliding axis with respect to the sleeve 330 and the positioning, i.e. (stable) locking of the tubular body 300 in a plurality of positions along the sliding axis X.

In particular, the tubular body 300 is slidably movable along the sliding axis X between a maximum dosing position of the pump, wherein the distance of the tubular body 300, i.e. of the second end of the tubular body 300 (i.e. from the end of the sleeve 330 fixed to the motor), from the motor is minimum and a percentage of the inner volume of the tubular body 300 occupied by the output shaft (when the output shaft is at the BDC) is maximum, and a minimum dosing position, wherein the distance of the tubular body 300 (i.e., from the end of the sleeve 330 fixed to the motor), i.e. of the second end of the tubular body 300, from the motor is maximum and a percentage of the inner volume of the tubular body 300 occupied by the output shaft (when the output shaft is at the BDC) is minimum. Furthermore, in the minimum dosing position, when the output shaft 31 is at the TDC, the free end of the output shaft 31 may be external to the inner volume of the tubular body, for example it may also be external to the housing seat, preferably it is totally external to the entire tubular body 300. In the embodiment shown at the TDC, the free end is located in the anti-stagnation duct 410.

Thus, going from the minimum dosing position towards the maximum dosing position, the free end of the output shaft, when it is at the TDC, moves closer to the outlet port 320 of the tubular body 300 and gradually increases the section of the output shaft within the inner volume of the tubular body 300 (which thus pushes out a greater amount of the second liquid) considered when the output shaft is at the BDC.

In particular, after a section wherein the distance of the free end of the output shaft from the outlet port of the tubular body decreases, until it becomes zero, it then increases again in a direction in which, however, the distance of the free end from the inlet port 315 decreases.

The amount of the second liquid pumped may be roughly calculated by determining the volume of output shaft 31 between the free end of the output shaft and the outlet port 320 of the tubular body 300 when the output shaft is at the BDC

As the point of the output shaft at said outlet port varies by moving the tubular body 300, also the size of said section between the outlet port and the free end varies, so the volume of second liquid pumped through the outlet port varies.

The stroke of the output shaft between the BDC and the TDC does not vary, i.e. it is constant. In other words, the distance of the free end in relation to a reference point taken on the motor (measured in a direction parallel to the sliding axis X), when the output shaft is at the BDC, is always the same.

The position varying mechanism allows the tubular body to be moved along the sliding axis and to lock the sliding thereof in a plurality (infinite to continuous) of positions between the maximum dosing position and the minimum dosing position.

The position varying mechanism comprises a ring nut mechanism having a ring nut 430 rotatably associated with the sleeve and coaxial to the sliding axis X. In particular, said ring nut 430 is provided with a single residual degree of freedom in rotation about the sliding axis and is provided with an inner thread 435 which meshes with an external thread 440 integral (without residual degrees of freedom) with the tubular body. A rotation of the ring nut 430 thereby corresponds to a translation of the tubular body along the sliding axis.

Such an outer thread 440 may be formed on the outer tubular surface of the tubular body 330, however preferably it is formed in an additional tubular body 445, 425 which is integral with the tubular body 330, at least sliding about the sliding axis X.

The additional tubular body 445, 425 comprises an (annular) step made in one inner tubular surface thereof and facing the motor, which goes into an (annular) step facing the first end of the tubular body 300 and the plug 400 clamps the further tubular body between itself and the step of the tubular body 300, thus making the tubular body integral with the further tubular body.

In the embodiment of FIGS. 8 and 9, the additional tubular body 445 is a cylindrical body provided with an axial cavity that is open at both opposite longitudinal ends of the cylindrical body itself and wherein the tubular body 300 is inserted.

In the embodiment of FIGS. 1-7 and 12, the additional tubular body is the containment tubular body 425

Returning to the ring nut, it has an enlarged end 450 (radially enlarged) which is housed in a conjugate annular groove formed in an enlarged portion of the sleeve 330 at the end of the sleeve that is distal from the motor.

This end of the sleeve 330 is then associated with a closing cover 455 configured to keep the enlarged end of the ring nut 430 in the annular groove.

Thanks to this configuration, the ring nut is associated to the sleeve with only one residual degree of freedom in rotation about the sliding axis X.

The sleeve 330 may comprise a locking system configured to selectively mechanically lock the tubular body 300, i.e. the additional tubular body, in a reached position, relative to the sleeve 330.

For example, the locking system is configured to mechanically lock by realising a form constraint, i.e. by making an obstacle connection.

Preferably, the form constraint, i.e. the obstacle connection, which locks the relative movement between the tubular body 300, i.e. the additional tubular body, and the sleeve is made by radially acting on an external surface of the ring nut, in particular of its enlarged portion.

Such locking system comprises a lever, which is housed in a seat at the enlarged portion of the sleeve and which is constrained to the seat of the sleeve by means of a joint hinge with an axis parallel to the sliding axis of the output shaft.

The lever has, at one end, a portion provided with reliefs and/or grooves, e.g. provided with a notching, adapted to engage with said outer portion of the ring nut 430 provided with reliefs and/or grooves configured to create a form constraint with the reliefs and/or grooves of the portion.

The operation of the proportional volumetric dosing device 10 takes place according to the following modes.

When the first liquid is supplied to the motor through the inlet port, the piston is at its BDC and is pushed by the first liquid towards a TDC thereof. In fact, in this position the inner valve of the piston is closed and the outer valve is open, and the first liquid exerts a pressure on part of the first face of the cylindrical body of the piston, which translates towards the TDC.

The movement towards the top dead centre of the piston draws with it also the rod 220, the raised element of which is kept in abutment against the upper abutment element of the guide of the piston.

The rising movement of the rod 220 continues until the rod meets an end-of-stroke abutment placed in the lower portion of the lid of the motor body.

At this point, the rod stops but the piston continues its stroke upwards for a short section as said piston may continue to slide upwards thanks to the through hole in which the rod slides.

As the springs are fixed on one side to the pin on the rod, and on the other side to the hinge, they are placed in traction and are inclined gradually downwards assuming a greater inclination than that of the connecting rods.

At that point the spring mechanism is triggered and the connecting rods are brought from the position in which they were in contact with the upper surface of the hole of the slot to a position in which they come into contact with the lower surface of the hole of the slot. Thus the connecting rods open the inner valve, because the shutter of the inner valve moves away from the valve seat and, causing the rotation of the rocker arm, they simultaneously close the outer valve.

Thus, the thrust of the first liquid on the first face of the first cylindrical body 60 of the piston is lost, and at the same time the first chamber also fills with the first liquid which flows through the open inner valve.

The piston therefore starts to descend towards the bottom dead centre until the rod comes into contact with the shank.

The movement towards the bottom dead centre of the piston is also transmitted to the small dosing piston and the friction gasket reaches the open position of the openings so as to let the second fluid flow through.

At this point, the rod stops but the piston continues its descent for a short section as said piston can still slide with respect to the rod making use of the through hole.

The springs 200 are again placed in traction and are inclined, this time upwards, gradually assuming a greater inclination than that of the connecting rods.

At that point the spring mechanism is triggered again and the connecting rods are snapped from the position in which they were in contact with the lower surface of the slot to a position in which they come into contact with the upper surface of the slot.

Thereby they close the inner valve and simultaneously open the outer valve and the cycle starts again with the methods previously seen.

The movement of the piston between the TDC and the BDC drags the output shaft 31 with it between the TDC position and the BDC position (there is correspondence between the top dead centre position of the piston and the top dead centre position of the output shaft and between the bottom dead centre position of the piston and the bottom dead centre position of the output shaft), allowing a predetermined amount of the second liquid present in the inner volume of the sleeve 330, i.e. in the pumping chamber, to be pumped. In particular, starting from the TDC and going towards the BDC, depending on the minimum or maximum dosing position in which the tubular body 300 is placed, the output shaft can be external to the annular sealing gasket 350, 350′ and be inserted into the inner annular surface 355, or in the through-hole made available by such surface, or be already inserted in said surface. In both cases, at the top dead centre or when the output shaft begins to enter the inner annular surface 355, the annular sealing gasket 350, 350′ is sealingly housed in its respective housing seat.

From the moment of such stroke to the BDC wherein at least the free end of the output shaft 31 is sealingly inserted in the inner annular surface 355, the pressure in the inner volume of the tubular body 300, i.e. in the pumping chamber, starts to increase because the second liquid cannot exit the inlet port of the tubular body 300 due to the one-way valve 395 and because the pushing device keeps the annular sealing gasket 350, 350′ sealed in its housing seat. As this pressure increases, at a certain point it overcomes the force/thrust of the pushing device, i.e. of the spring 405, and causes the translation of the annular sealing gasket along the sliding axis X in the direction moving away from the abutment surface 380 of the housing seat.

When the portions of the housing seat and the annular sealing gasket which create the hermetic sealing are not in contact and do not create the hermetic sealing, the through-hole and/or the groove of the housing seat and/or the groove of the annular sealing gasket and/or the gap present between the annular sealing gasket and the side surface 385 is in fluid communication with the outlet port 320 of the tubular body 300 and the second liquid can thus reach (by also flowing through the hole of the holding body and/or the anti-stagnation duct) the inner volume of the sleeve 330.

In particular, as it may be seen in FIG. 6 which shows the condition in which the second liquid is being pumped into the inner volume of the sleeve, in case the annular sealing gasket has the protrusions 375, once the first face of the annular sealing gasket is not in contact with the abutment surface, the second liquid can flow from the outlet port 320 into a gap formed between the abutment surface and the second face of the annular sealing gasket and from there into the gap between the annular sealing gasket and the side surface 385 and into the groove present between two protrusions 375 adjacent to each other. From there, the second liquid can then flow into the inner volume of the sleeve 330, e.g. by first passing through the through-hole of the holding body and into the anti-stagnation duct.

When, on the other hand, grooves 390 are present in the housing seat, once the first face of the annular sealing gasket is not in contact with the abutment surface, the second liquid can flow from the outlet port 320 into a space created between the abutment surface and the second face of the annular sealing gasket and from there into the gap between the annular sealing gasket and the side surface 385 and into the grooves 390, towards the inner volume of the tubular body.

For example, the second liquid overtaking the gasket 30, 350′ firstly flows through the through-hole of the holding body and into the anti-stagnation duct 410.

Once the BDC is reached, the percentage of the inner volume of the tubular body, i.e. of the pumping chamber, occupied by the output shaft 31 is maximised, and since this occupied volume no longer increases and the second liquid displaced by the output shaft has already flowed through the outlet port 320, the thrust exerted by the pushing device, i.e. by the spring 405, brings the annular sealing gasket back into the housing seat to create the fluidic sealing with the housing seat.

During the stroke of the output shaft from the BDC to the TDC, the pushing device keeps the annular sealing gasket in its housing seat by creating a fluidic sealing, despite the fact that the friction of the output shaft with the inner annular surface 355 would tend to lift the annular sealing gasket out of its housing seat again (since the pushing device generates a thrust greater than this friction and in the direction opposite to the force generated by such friction). At the same time, as a result of this sealing exerted by the annular sealing gasket under the thrust of the pushing device, at least until the output shaft has at least a section inserted in the inner annular surface 355, a depression is generated in the inner volume of the tubular body, i.e. in the pumping chamber, as a result of which the one-way valve 395 moves to the open position allowing to draw in the second liquid which flows through the inlet port 315 and enters the inner volume of the tubular body 300, i.e. in the pumping chamber.

When the output shaft exits the inner annular surface 355 or when it reaches the top dead centre, the volume of the pumping chamber occupied by the output shaft 31 is minimal or zero (depending on whether the free end of the output shaft when it is at the TDC is still inside the inner volume of the tubular body 300) and since this occupied volume no longer decreases and there is no longer a sealing on the inner annular surface 355, the depression within the inner volume, i.e. in the pumping chamber, is lost, and the one-way valve 395 moves to the closed position, isolating the inner volume from a supply pipe of the second liquid connected to the pump.

When the TDC is reached, the movement direction of the output shaft is reversed again and the pumping cycle begins again.

When the second liquid reaches the inner volume of the sleeve, from there, depending on the presence or not of the by-pass, it can mix with the first liquid in the motor body or in the outlet duct.

It should be noted that in this disclosure, rigid means not noticeably deformable under the normal working loads which it is subjected to. In other words, a rigid element does not perform the function for which it was designed even by a deformation thereof.

An elastic element refers to a body that is shaped so as to deform (only) elastically under the working loads to which it is subjected and therefore also (or only) performs its function by its own elastic deformation. It must be specified that the definition “elastic deformation” is to be understood as opposed to “plastic deformation”, which plastic deformation is the type of deformation wherein the body submitted to deformation does not take its original shape back once it is no longer submitted to the deforming force.

In the present case a gasket is elastically deformed to adhere to the concerned surfaces in order to generate a possibly hermetic sealing.

Furthermore, it must be specified that single-piece body refers to a body obtained from the solidification of a single casting, or injection, of (a single) material into a mould and, possibly, by a subsequent processing of said solidified body by removing material.

The terms to measure and with a small a clearance mean that the elements characterised by such a coupling can slide in relation to each other without any particular effort, thus with a small friction, and without tilting appreciably relative to the sliding direction. If, on the other hand, there is a large amount of clearance, the elements may tilt appreciably in the advancement direction and get stuck.

The invention thus conceived is susceptible to several modifications and variations, all falling within the scope of the inventive concept.

Moreover, all the details can be replaced by other technically equivalent elements.

In practice, the materials used, as well as the contingent shapes and sizes, can be whatever according to the requirements without for this reason departing from the scope of protection of the following claims.

1. A proportional volumetric dosing device, comprising:
a motor provided with an inlet port of a first liquid and an output shaft movable along a respective sliding axis between a top dead centre position and a bottom dead centre position, and
a pump fixed to the motor and adapted to be driven by said output shaft, said pump comprising:
a tubular body coaxial to the output shaft and provided with an inner tubular surface defining a pump inner volume in which the output shaft is partially inserted in its movement between the bottom dead centre and top dead centre, said tubular body comprising a first longitudinal end, distal from the motor, near or at which the inner tubular surface makes available an inlet port of a second liquid to be pumped, and an opposite second longitudinal end, proximal to the motor, and near or at which the inner tubular surface makes available an outlet port of the second liquid,
a sleeve which connects the tubular body to the motor and provided with an inner volume in fluid communication with the outlet port of the second liquid,
an annular sealing gasket, which gasket is provided with: an inner annular surface into which a section of the output shaft sealingly slides, at least when the output shaft is at the bottom dead centre, an outer annular surface opposite the inner annular surface, a first face connecting the inner annular surface to the outer annular surface, and a second face opposite the first face,
a pushing device which generates a thrust on the annular sealing gasket in a direction that keeps the annular sealing gasket in contact with the housing seat and creates a hermetic sealing with it.

2. The proportional volumetric dosing device according to claim 1, wherein the housing seat of the annular sealing gasket comprises an abutment surface which originates from the inner tubular surface of the tubular body in a direction moving away from the sliding axis and transverse thereto, and a side surface which is coaxial to the sliding axis and extends from the abutment surface transverse to the abutment surface,
wherein at least either an annular portion of the first face and an annular portion of the abutment surface, or a portion of the outer annular surface and a portion of the side surface of the housing seat, achieve a hermetic sealing under the thrust exerted on the annular sealing gasket by the pushing device when the annular sealing gasket is in the closed position, and
wherein one of the annular sealing gasket and the housing seat comprises a groove or a hole which fluidically connects the inner volume of the tubular body with the inner volume of the sleeve when the annular gasket is in the open position, in which open position said annular portions, which create the hermetic sealing under the thrust of the pushing device in the closed position, are spaced apart from each other.

3. The proportional volumetric dosing device according to claim 1, comprising an anti-stagnation duct, defining a narrow portion of the housing seat of the annular gasket opposite the abutment surface, which extends in the direction moving closer to the motor and which is crossed by the motor output shaft.

4. The proportional volumetric dosing device according to claim 1, comprising a body retaining the pushing device, which holding body is crossed by the output shaft, is removably fixed to the tubular body, and holds the pushing device in position.

5. The proportional volumetric dosing device according to claim 1, comprising a body retaining the pushing device, which holding body is crossed by the output shaft and is permanently fixed to the tubular body, and wherein the tubular body is removably connected to the sleeve.

6. The proportional volumetric dosing device according to claim 5, comprising:
a one-way valve housed in a respective housing seat made at the first end of the tubular body and acting on the inlet port of the second liquid,
an additional tubular body, into which the tubular body is inserted, provided with a first longitudinal end that is proximal to the motor and an opposite second longitudinal end, where said first longitudinal end has a bottom wall transverse to the sliding axis, which is crossed by the output shaft and on which the second longitudinal end of the tubular body or the holding body abuts,
wherein the second longitudinal end is partially closed by a plug associated with the additional tubular body and the one-way valve is clamped between the housing seat thereof and the plug.

7. The proportional volumetric dosing device according to claim 1, wherein the pushing device comprises a helical compression spring.

8. The proportional volumetric dosing device according to claim 4, wherein the coil spring comprises a first end in contact with the annular sealing gasket and an opposite second end in contact with the holding body, and wherein the holding body comprises a groove into which a turn of the second end is retaining.

9. The proportional volumetric dosing device according to claim 1, wherein the inner volume of the sleeve is in fluid communication with the inner volume of the motor in fluid communication with the inlet port of the first liquid or with a dosing device by-pass duct.

10. The proportional volumetric dosing device according to claim 1, wherein the tubular body of the pump is movably associated with the motor, i.e. to the sleeve, in a sliding manner along the sliding axis X, and the pump comprises a position varying mechanism of the tubular body, configured to allow the sliding of the tubular body along the sliding axis relative to the sleeve and the positioning of the tubular body in a plurality of positions along the sliding axis X.

11. The proportional volumetric dosing device according to claim 7, wherein the coil spring comprises a first end in contact with the annular sealing gasket and an opposite second end in contact with the holding body, and wherein the holding body comprises a groove into which a turn of the second end is retaining.
